(19) United States
(12) Patent Application Publication
(10) Pub. No.: US 2010/0049559 A1
(43) Pub. Date: Feb. 25, 2010

(54) METHOD AND SYSTEM FOR FOCUSED AND SCALABLE EVENT ENRICHMENT FOR COMPLEX IMS SERVICE MODELS

(75) Inventors: Giancarlo CARBONE, Rome (IT); Luigi PICHETTI, Rome (IT); Francesco LECCISO, Rome (IT); Stefano SIDOTI, Rome (IT); Luisa ATTANASIO, Rome (IT); Giuseppe CIANO, Rome (IT)

Correspondence Address: Locke Lord Bissell & Liddell LLP;Attn: IP Docketing, Three World Financial Center, New York, NY, 10281-2101, US

(73) Assignee: International Business Machines Corporation, Armonk, NY (US)

(21) Appl. No.: 12/195,740

(22) Filed: Aug. 21, 2008

(51) Int. Cl. G06Q 10/00

(52) U.S. Cl. 705/7

(57) ABSTRACT

A system and method for focused and scalable event enrichment for information management system service models in which a monitoring agent monitors one or more IT components running on one or more end-points. When an event probe is installed, a local metadata cache is primed with metadata stored on a metadata server. After a monitoring agent receives an event from an end-point, the event is enriched with metadata stored in the local metadata cache. The enriched event is then uploaded to an event monitoring server. A business service manager server uses the enriched events stored on the event monitoring server to manage the service model and to quickly determine service status based on service impacting events.

### FIELD OF THE DISCLOSURE

The disclosure relates generally to business service management. More particularly, the disclosure relates to a system and method for focused and scalable event enrichment for complex service models, such as, for example, IP Multimedia Subsystem (IMS) service models.

### BACKGROUND

Business services involve a service that is delivered to a business customer by a business unit. Business services may be, for example, the delivery of financial services to the customers of a bank, or goods to the customers of a retail store. With advances in computers and information technology (IT), IT services play an increasingly important role in the successful delivery of business services.

Typically, business services are governed by a service level agreement (SLA) between the business service provider and the customer. Through the SLA, a business service provider commits to providing a certain level of service that is satisfactory to the customer. Usually, the availability of the business service to the customer is the most important aspect of the SLA. Business service management seeks to manage IT components and services within this context so that business services can be effectively and reliably delivered to the customer.

The level of the business service being provided is usually measurable to allow both the business service provider and the customer to determine compliance with the terms of the SLA. Accordingly, the service provider should have the ability to assess the impact of any and all events on the level or availability of the business service being provided. Relevant events may include, for example, IT component failures or outages, and performance threshold violations. The service provider should also have the ability to use this feedback to expeditiously adapt its business service system, including associated IT components, to the occurring events in order to eliminate or minimize disruption of business service delivery.

One way to manage business service quality and availability is to enrich events (i.e., messages, alerts, notifications, etc.) with additional information that enables quick and meaningful action by the service provider when the events are received. Currently, software tools such as Tivoli® Business Service Manager (TBSM) for service modeling and Omnibus (an Event Management Server or EMS) for health monitoring use external databases to enrich events with specific customer attributes. For example, when a new service instance is created within TBSM, a policy may be invoked whereby an external database is queried and uses one or more existing attributes of the service (e.g., hostname and IP port number) to determine the geographical location of the machine where the service instance is running. However, this approach only works if the customer already has the relevant information organized within a database such that the information can be used to quickly enrich the received event and, if it is relevant to the service model, forward the enriched event to the business service manager.

Often, the information to enrich the events is dispersed or distributed in a manner that makes event enrichment less efficient. For example, the information may not be suitably organized in a database or may be provided by an external source that is not accessible at all times. Moreover, as the service model becomes complex, or the number of events or IT components increase, it is neither convenient nor scalable to upload all possible raw events to the Event Management Server (EMS) and to rely on the EMS to take the necessary steps to enrich service impacting events.

Existing systems may include a monitoring agent, an event monitoring server, a business service manager server, and a source of information, such as a metadata server, for service enrichment. The monitoring agent receives an event and sends it to the event monitoring server before the event is enriched. The business service manager server uses the non-enriched event stored within the event monitoring server to create a partial service model and to determine service instance status based on the event. The business service manager server then invokes specific policies to enrich the service model instance with additional or missing attributes from the source and updates the service model accordingly.

One drawback to existing systems is that the IT components involved in delivering business services (i.e., the event monitoring server and business service manager server) are involved in complex event enrichment processes before knowing whether the event has any meaningful impact on service delivery or where the event may impact the service model. Additionally, when the information to enrich events is not conveniently available, or the complexity of the service model grows, the EMS (or even IT personnel) is burdened with processing the event, obtaining additional information to enrich the event, assessing service instance status, and maintaining the relevant service model. This burden on the EMS increases the likelihood that the level of service to the customer will diminish, or, in some cases, service may be interrupted.

### SUMMARY

The present disclosure relates to a system and method for enriching events in the context of an IMS environment so that a business service model may be implemented and managed, and service delivered to a customer in a more efficient and effective manner. More particularly, events are enriched at an end-point with information stored in a local cache. The enriched events are then sent to an event monitoring server which in turn provides the pre-enriched events to a business service manager server. Using the pre-enriched events, the business service manager server is better able to manage the service model and determine service instance status. The IT components that manage the delivery of service to the customer are not directly involved in the event enrichment process and are able to respond to only those events that may impact the level of service being provided. Accordingly, a service provider is better equipped to provide a specified level of service to a customer and can more readily avoid service interruptions.

In one embodiment a monitoring agent monitors one or more IT components running on one or more end-points. When an event probe is installed, a local metadata cache is primed with metadata stored on a metadata server. After a monitoring agent receives an event from an end-point, the event is enriched with metadata stored in the local metadata cache. The enriched event is then uploaded to an event monitoring server. A business service manager server uses the enriched events stored on the event monitoring server to manage the service model and to quickly determine service status based on service impacting events.

### BRIEF DESCRIPTION OF THE DRAWINGS

FIG. 1 is a diagram of a system, in accordance with the disclosure herein, used to implement and manage business service models.

### DETAILED DESCRIPTION

In the following description, reference is made to the accompanying figure which illustrates one exemplary embodiment of how the system and method disclosed herein may be practiced. It is to be understood, however, that those skilled in the art may develop other structural and functional modifications without departing from the scope of the present disclosure.

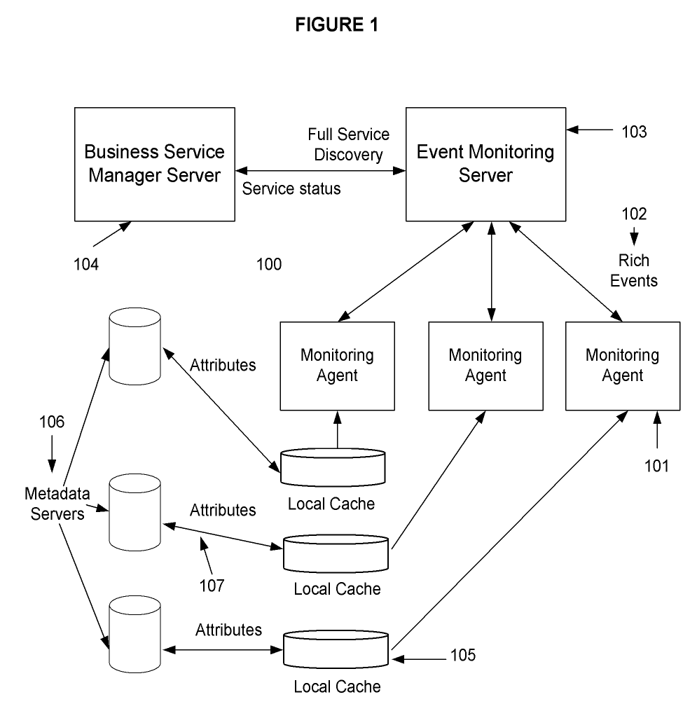

With reference to FIG. 1, one embodiment of a system in accordance with this disclosure is illustrated. System (100) may comprise a monitoring agent (101), a local metadata cache (105), an event monitoring server (103), a business service manager server (104), and a metadata server (106). It will be understood that the individual components that make up this illustrative embodiment are well-known in the art.

Monitoring agent (101) may monitor one or more IT resources of a complex service model environment, such as, for example, a complex IP Multimedia Subsystem (IMS) environment. The one or more IT resources monitored by monitoring agent (101) may be, for example, network components (e.g., routers or switches), servers, storage devices, operating systems, or applications (e.g., databases or web applications). Each IT resource may encompass one or more end-points. An end-point can be considered any source of events. Events will be understood to be any type of communication of information from the end-point, such as messages, indicators, notifications, and the like. The number of IT resources and associated end-points can vary and may depend upon, among other factors, the specific service being offered, the design of the specific system, and/or capacity constraints. Monitoring agent (101) can be configured to receive events from any and all end-points.

Monitoring agent (101) may be configured to communicate with a local metadata cache (105). The local metadata cache (105) can store metadata obtained from a metadata server (106). The metadata server (106) can be any suitable data repository, including those locally or remotely situated with respect to the monitoring agent (101) and local metadata cache (105). The metadata obtained from the metadata server (106) may be, for example, an attribute (107). The attribute (107) can be any information related to the service and may encompass, for example, customer information, geographical location, and department information.

An event probe, similar to, for example, the Tivoli® Event Integration Facility (EIF) probe, allows events generated by end-points to be forwarded from the monitoring agent (101) to the event monitoring server (103). During the installation of an event probe (not shown) at the monitoring agent (101), metadata information, which may contain an attribute (107), is retrieved from the metadata server (106) and is stored in the local metadata cache (105). After events are generated at an end-point and are received by the monitoring agent (101), the event is enriched using the metadata information, such as attribute (107), stored in the local cache (105). More particularly, attribute (107) can be compactly coded into the event to create an enriched event (102). The enriched event (102) may then be sent to the event monitoring server (103) by the monitoring agent (101).

After the event monitoring server (103) receives the enriched event (102), the event monitoring server (103) may respond in different ways depending on how the enriched event (102) is determined to affect the service model and service instance status. For example, if the event monitoring server (103) determines that the enriched event (102) is a service impacting event, the event monitoring server (103) can immediately send the enriched event (102) to the business service manager server (104) so that the business service manager server (104) can manage the service model, determine service instance status, and appropriately respond to the enriched event (102). Conversely, if the event monitoring server (103) determines that the enriched event (102) is not a service impacting event, the enriched event (102) can be ignored and will not be sent to the business service manager server (104).

Because the business service manager server (104) receives pre-enriched events from the event monitoring server (103), such as enriched event (102), the business service manager server (104) is able to more efficiently and effectively manage the service model and determine service instance status. Additionally, because certain enriched events (102) may be ignored by the event monitoring server (103) and not be sent to the business service manager server (104), such events do not consume system resources. Moreover, since the event monitoring server (103) and the business service manager server (104) are not involved in burdensome event enrichment processes, more complex service models can be implemented, such as, for example, IP Multimedia Subsystem (IMS) environments.

Operation of the system disclosed herein will be further illustrated by the following example. A business service provider operates and maintains data centers in several separate geographical locations, all of which provide hosting services for a customer's online retail business. The service provider and customer have a SLA requiring the service provider to provide year-round, uninterrupted hosting services at a capacity suitable to meet the customer's forecasted level of sales. End-points on the service provider's IT system, such as a server hosting the customer's retail website, are configured to generate events which indicate the hosting server's status, including server temperature and CPU utilization. As generated, an event may only communicate basic information, such as that the temperature or CPU utilization level of the hosting server is high.

A service provider will want to address these types of events expeditiously in order to maintain continuity of service and compliance with the SLA. Providing additional information about the event will allow for a quick response after the event is generated. Such additional information may include the geographical location of the hosting server that generated the event and the contact information of the appropriate maintenance personnel in that geographical location. For example, a generated event may provide the following information: “CPU Utilization High on Host Server 0003.” It will be understood that an event may communicate any relevant information in any suitable form. After receiving this event, the service provider or, for example, the service provider's business service manager server (104), must consume time and resources identifying where the host server is located and who the appropriate response personnel may be.

Enriching the event at the end-point where it is generated would reduce the time and resources necessary to address an event that may impact service levels. In this example, a remote data repository, such as metadata server (106), contains information including the geographic location of the host servers and contact information for the appropriate service personnel. The local metadata cache (105) is uploaded with this information during the installation of an event probe, and may be periodically updated with information from the metadata server (106) at relevant intervals, such as, for example, a service change, to ensure that the local metadata cache (105) contains up-to-date information. When the event “CPU Utilization High on Host Server 0003” described above is generated, the monitoring agent (101) may enrich the event with additional relevant information. For example, “Host Server 0003” is located in San Jose and that facility has a service and maintenance contract with John Doe Service Co. Accordingly, the original event may become enriched event (102) which provides the following information: “CPU Utilization High on Host Server 0003, Location: San Jose, Service Contract with John Doe Service Co, Contact John Doe, Ext 5555.”

The enriched event (102) is sent by the monitoring agent (101) to the event monitoring server (103) where it may be determined that enriched event (102) is a service impacting event. The event monitoring server (103) may send the enriched event (102) to the business service manager server (104) which in turn may determine service status and initiate contact with the maintenance personnel to address the potentially service impacting event. As can be understood from this example, enriching an event at the end-point can allow the service provider to better determine which events may impact service to a customer and reduce the time and resources involved in responding to the event. Additionally, since components of the service provider's information management system, such as the event monitoring server (103) and business service manager server (104) are not involved in complex event enrichment processes, resources are directed to maintaining a level of service to the customer that is compliant with the SLA, and interruptions in service can be minimized or eliminated.

It will be appreciated by persons skilled in the art that the present disclosure is not limited to what has been particularly shown and described hereinabove. Rather, the scope of the present disclosure is defined by the claims which follow. It should further be understood that the above description is only representative of illustrative examples of embodiments. For the reader's convenience, the above description has focused on a representative sample of possible embodiments, a sample that teaches the principles of the present disclosure. Other embodiments may result from a different combination of portions of different embodiments.

The description has not attempted to exhaustively enumerate all possible variations. Although some alternate embodiments may not have been presented in the present disclosure, it is not to be considered a disclaimer of those alternate embodiments. It will be appreciated that there are undescribed embodiments that either fall within the literal scope of the following claims, or that are equivalent thereto.

What is claimed is:

1. A method of end-point event enrichment for IMS service models, comprising:
monitoring an end-point with a monitoring agent;
installing an event probe at the monitoring agent;
retrieving information from a metadata server when the event probe is installed at the monitoring agent;
storing the information from the metadata server in a local metadata cache;
receiving an event from the end-point;
enriching the event with the information stored in the local metadata cache;
sending the enriched event to a business service manager server via an event monitoring server, whereby the enriched event is used to manage a service model.
